(19) United States
(12) Patent Application Publication
(10) Pub. No.: US 2026/0339255 A1
(43) Pub. Date: Oct. 29, 2026

(54) IMAGE FORMING APPARATUS AND IMAGE FORMING APPARATUS CONTROL METHOD

(71) Applicant: KYOCERA Document Solutions Inc., Osaka (JP)

(72) Inventors: Masayuki Mochizuki, Osaka (JP); Takuya Aritsuki, Osaka (JP); Hayato Kusuda, Osaka (JP)

(21) Appl. No.: 19/637,559

(22) Filed: Apr. 2, 2026

(30) Foreign Application Priority Data
Apr. 23, 2025 (JP) 2025-071055

(51) Int. Cl. G03G 15/00

(52) U.S. Cl. CPC G03G 15/6564; G03G 15/50; G03G 2215/00599

(57) ABSTRACT

An image forming apparatus includes a conveying control portion that conveys a sheet so that the sheet reaches a forming position at timing when image formation begins. The conveying control portion changes a conveying speed of the sheet without stopping the sheet midway during a specific period from a reference position on a conveying path along which the sheet is conveyed until the sheet reaches the forming position. The conveying control portion restores the conveying speed of the sheet to the conveying speed before the speed change before the sheet reaches the forming position.

### INCORPORATION BY REFERENCE

This application is based upon and claims the benefit of priority from the corresponding Japanese Patent Application No. 2025-071055 filed on Apr. 23, 2025, the entire contents of which are incorporated herein by reference.

The present disclosure relates to an image forming apparatus and an image forming apparatus control method.

### BACKGROUND

As a related technology, an image forming apparatus is known that synchronizes timing at which a transferred image formed on an intermediate transfer member reaches a transfer position (forming position) with timing at which a sheet reaches the transfer position without stopping conveying of the sheet. In this image forming apparatus, a sheet conveying speed is accelerated or decelerated depending on the timing at which a leading edge of the sheet reaches a detection position so that the leading edge of the sheet reaches at a reference time.

### SUMMARY

An image forming apparatus according to one aspect of the present disclosure includes a conveying control portion that conveys a sheet so that the sheet reaches a forming position at a timing when image formation begins. The conveying control portion changes a conveying speed of the sheet without stopping the sheet midway during a specific period from a reference position on a conveying path along which the sheet is conveyed until the sheet reaches the forming position. The conveying control portion restores the conveying speed of the sheet to the conveying speed before the speed change before the sheet reaches the forming position.

An image forming apparatus control method according to another aspect of the present disclosure includes conveying a sheet so that the sheet reaches a forming position at a timing when image formation begins. The image forming apparatus control method includes changing the conveying speed of the sheet without stopping the sheet midway during a specific period from a reference position in a conveying path along which the sheet is conveyed until the sheet reaches the forming position. The image forming apparatus control method includes restoring the conveying speed of the sheet to the conveying speed before the speed change before the sheet reaches the forming position.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic cross-sectional view showing a configuration of an image forming apparatus according to an embodiment.

FIG. 2 is a schematic diagram showing a configuration of main parts of an image forming apparatus according to an embodiment.

FIG. 3 is a schematic block diagram showing a configuration of an image forming apparatus according to an embodiment.

FIG. 4 is a schematic diagram showing an example of control of an image forming apparatus according to an embodiment.

FIG. 5 is a schematic diagram showing another example of control of an image forming apparatus according to an embodiment.

FIG. 6 is a flowchart showing an example of operation of an image forming apparatus according to an embodiment.

### DETAILED DESCRIPTION

### Embodiments

Hereinafter, embodiments according to the present disclosure will be described with reference to the drawings. The following embodiments are examples of specific embodiments according the present disclosure, and do not limit the technical scope of the present disclosure.

### 1. Image Forming Apparatus

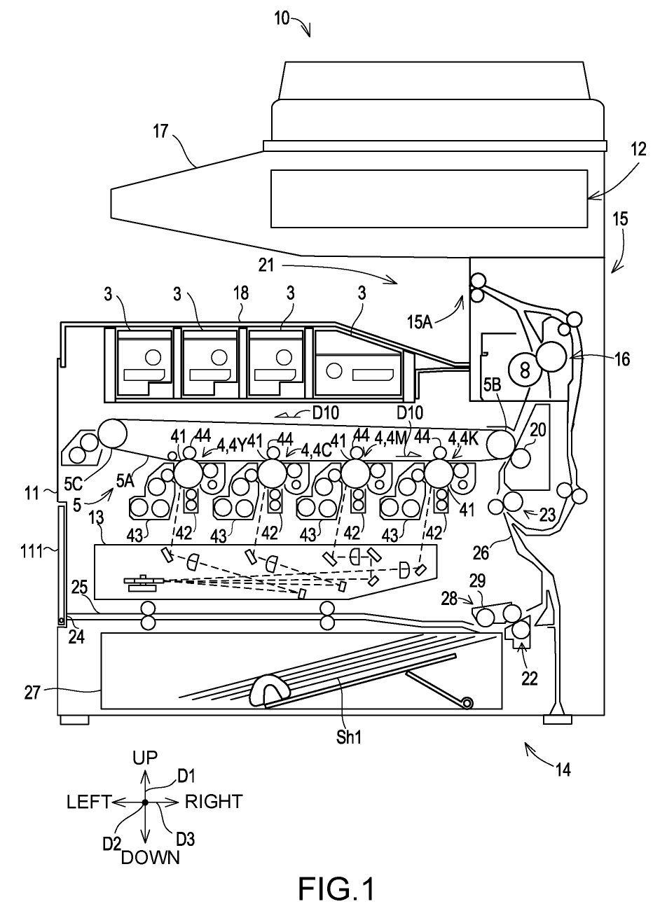

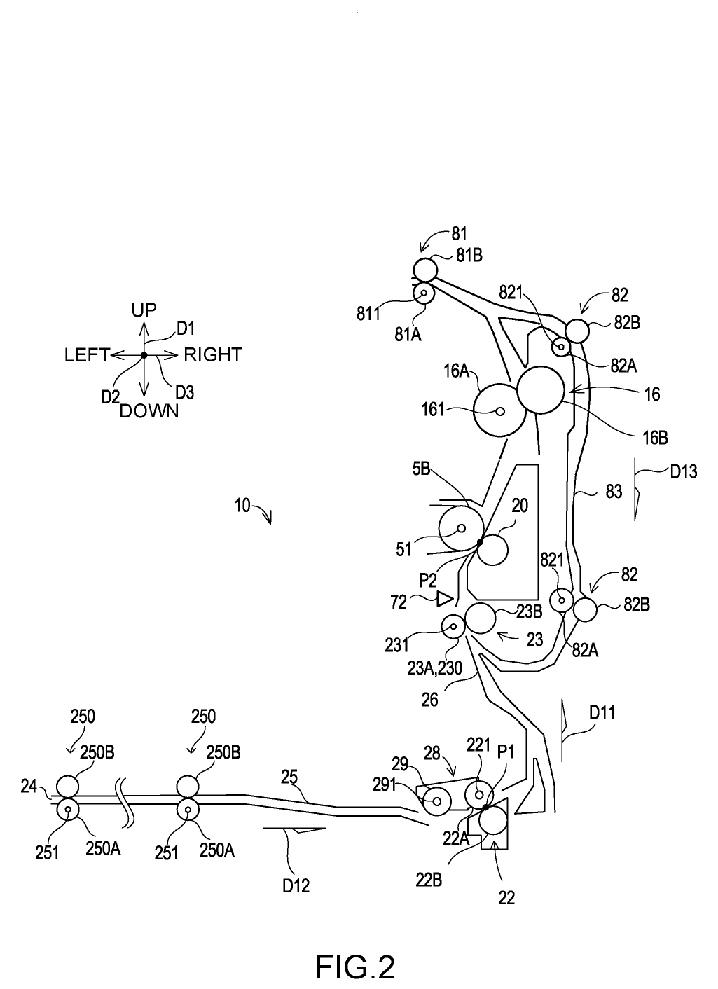

First, an overall configuration of an image forming apparatus 10 according to the present embodiment will be described with reference to FIGS. 1 and 2. In the following description, an up-down direction D1, a front-rear direction D2, and a left-right direction D3 are defined based on a state in which the image forming apparatus 10 is installed and ready for use (state in FIG. 1).

As shown in FIG. 1, the image forming apparatus 10 is a multifunction peripheral capable of printing an image on a sheet Sh1 such as printing paper, and has various functions such as a printing function, a copy function, a facsimile function, and a scanning function. In the present embodiment, the image forming apparatus 10 further includes a double-sided printing function for printing images on both sides of the sheet Sh1. Note that the image forming apparatus 10 is not limited to a multifunction peripheral, but may be any device having a printing function for printing an image on a conveyed sheet Sh1, such as a printer, a copier, or a fax machine.

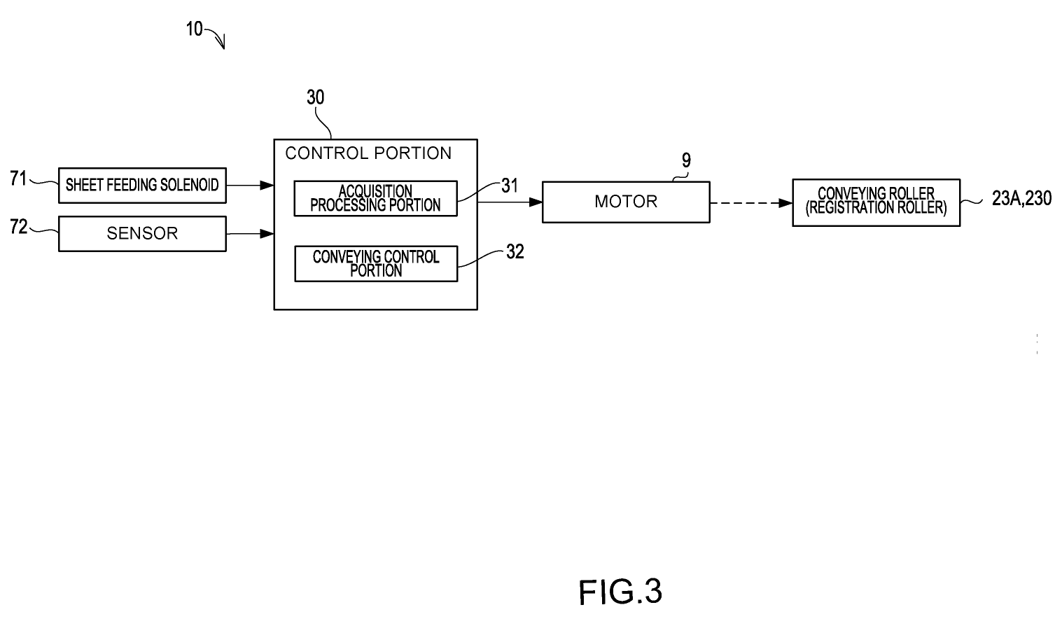

The image forming apparatus 10 includes an image reading portion 12, an image forming portion 14, an operation display portion 17, and a control portion 30 (see FIG. 3). The image reading portion 12 is a portion that performs a reading process to read an image of a document, and is provided on the upper part of the image forming apparatus 10. The image forming portion 14 is a portion that performs a process to form a monochrome or a color image based on an electrophotographic method, and is provided at a lower part of the image forming apparatus 10. In addition, a sheet discharge portion 15 is provided on a right side of the image forming portion 14.

Above the image forming portion 14, a discharge space 21 is provided. The sheet discharge portion 15 forms the discharge space 21 between the image forming portion 14 and the image reading portion 12, and connects the image forming portion 14 and the image reading portion 12 vertically.

The sheet discharge portion 15 discharges the sheet Sh1 onto which the image has been formed to the discharge space 21. A sheet discharge port 15A is formed on a left side surface of the sheet discharge portion 15 on the discharge space 21 side. The sheet Sh1 is discharged from the sheet discharge port 15A.

The image forming portion 14 includes a housing 11 as a main body of the apparatus. Various elements that make up the image forming portion 14 are provided inside the housing 11. The housing 11 includes an exterior frame that covers the entire image forming portion 14 and an internal frame that supports each component of the image forming portion 14.

A cover 111 for opening an inside portion of the housing 11 is provided on a front surface of the housing 11. The cover 111 is rotatably supported by a support shaft (not shown) that is provided at a lower end portion of an opening in the front surface of the housing 11 and extends in the front-rear direction D2.

When the cover 111 is open, a sheet feed port 24 provided on the front surface of the housing 11 is exposed to outside the housing 11. The sheet feed port 24 is used when a user manually inserts sheets Sh1 into the housing 11 one by one. Hereinafter, the sheet Sh1 inserted from the sheet feed port 24 will also be referred to as a "manually fed sheet".

The image forming portion 14 forms a monochrome image or a color image on a sheet Sh1 such as printing paper based on a so-called tandem system. As shown in FIG. 1, the image forming portion 14 includes a plurality of image forming units 4, an intermediate transfer unit 5, an optical scanning device 13, a secondary transfer roller 20, a fixing device 16, a sheet tray 18, a sheet storing portion 27, and a sheet feeding unit 28. In addition, the image forming portion 14 also includes a manual feed conveying path 25, a sheet conveying path 26 (hereinafter referred to as “conveying path 26”), a sheet correction unit 23, and a toner container 3. Furthermore, the image forming portion 14 includes a discharge roller pair 81, two double-sided printing feed roller pairs 82, a double-sided printing conveying path 83, and the like.

The conveying path 26 is a guide path that guides the sheet Sh1 fed by a sheet feeding roller pair 22 to the sheet discharge port 15A. The conveying path 26 curves upward from the sheet feeding roller pair 22 and then extends upward, passing through the secondary transfer roller 20 and reach the sheet discharge port 15A.

The sheet storing portion 27 is provided at a very bottom portion of the image forming apparatus 10. The sheet storing portion 27 is a portion for storing sheets Sh1 onto which images are transferred by the image forming unit 4, and is configured, for example, in a shape of a tray with an open top. The sheet storing portion 27 is supported by the housing 11.

The sheet feeding unit 28 takes out the sheets Sh1 stacked in the sheet storing portion 27 one by one, and feeds the sheets Sh1 toward the conveying path 26. The sheet feeding unit 28 includes a sheet feeding solenoid 71 (see FIG. 3), a pickup roller 29, and a sheet feeding roller pair 22. The sheet feeding solenoid 71, the pickup roller 29, and the sheet feeding roller pair 22 are provided on an upper right side of the sheet storing portion 27.

More specifically, as shown in FIG. 2, the sheet feeding roller pair 22 receives a driving force from a motor 9 (see FIG. 3) to convey the sheet Sh1 toward the downstream side in the conveying direction D11. The sheet feeding roller pair 22 includes a first drive roller 22A that rotates when a driving force is transmitted from the motor 9, and a first driven roller 22B that is rotationally driven by coming in contact with the first drive roller 22A.

The first drive roller 22A is fixed to a rotating shaft 221 extending in the front-rear direction D2, and the rotating shaft 221 is rotatably supported by an internal frame of the housing 11. The driving force from the motor 9 is transmitted to the rotating shaft 221. The driving force of the motor 9 is transmitted to the rotating shaft 221 via a transmission mechanism (not shown) such as a gear or a belt.

The first driven roller 22B is biased by a spring (not shown) with a predetermined elastic force toward the first drive roller 22A side. More specifically, a bearing portion (not shown) that supports a rotating shaft (not shown) of the first driven roller 22B is biased by a spring. Thus, the first driven roller 22B comes into contact with the first drive roller 22A while applying a predetermined pressure thereto. In this state, when the first drive roller 22A is rotationally driven, the first driven roller 22B is driven.

The sheet feeding solenoid 71 is driven in accordance with a control signal from the control portion 30. When the sheet feeding solenoid 71 is driven (in other words, is turned ON), the sheet feeding solenoid 71 moves the pickup roller 29 down. Thus, the pickup roller 29 comes into contact with the sheet Sh1 stored in the sheet storing portion 27 or the sheet Sh1 conveyed from the manual feed conveying path 25, and the sheet Sh1 can be fed to the conveying path 26. On the other hand, when the sheet feeding solenoid 71 stops (in other words, is turned OFF), the pickup roller 29 rises and is no longer in contact with the sheet Sh1.

The pickup roller 29 receives a driving force from the motor 9 to pick up the sheets Sh1 stored in the sheet storing portion 27 one by one and convey them to the sheet feeding roller pair 22. In addition, the pickup roller 29, by receiving a driving force from the motor 9, conveys the sheet Sh1 conveyed from the manual feed conveying path 25 to the sheet feeding roller pair 22. The sheet feeding roller pair 22 receives a driving force from the motor 9 to convey the sheet Sh1 conveyed from the pickup roller 29 to the conveying path 26. The pickup roller 29 and the sheet feeding roller pair 22 correspond to a sheet conveying device that conveys the sheet Sh1 to the conveying path 26.

The manual feed conveying path 25 is a guide path that guides the sheet Sh1 (manually fed sheet) inserted into the sheet feed port 24 to the pickup roller 29. The manual feed conveying path 25 extends rightward from the sheet feed port 24 and reaches the pickup roller 29 via two manual sheet feeding roller pairs 250.

As shown in FIG. 2, each of the two manual sheet feeding roller pairs 250, by receiving a driving force from the motor 9, conveys the sheet Sh1 inserted into the sheet feed port 24 toward the downstream side in the conveying direction D12. Each of the two manual sheet feeding roller pairs 250 has a second drive roller 250A that rotates when driving force is transmitted from the motor 9, and a second driven roller 250B that comes into contact with the second drive roller 250A and rotates in response to the second drive roller 250A.

The second drive roller 250A is fixed to a rotating shaft 251 extending in the front-rear direction D2, and the rotating shaft 251 is rotatably supported by an internal frame of the housing 11. The driving force from the motor 9 is transmitted to the rotating shaft 251. The driving force of the motor 9 is transmitted to the rotating shaft 251 via a transmission mechanism (not shown) such as a gear or a belt.

The second driven roller 250B is biased by a spring (not shown) with a predetermined elastic force toward the second drive roller 250A. More specifically, a bearing portion (not shown) that supports a rotating shaft (not shown) of the second driven roller 250B is biased by a spring. Thus, the second driven roller 250B comes into contact with the second drive roller 250A while applying a predetermined pressure thereto. In this state, when the second drive roller 250A is rotationally driven, the second driven roller 250B is driven.

More specifically, one of the two manual sheet feeding roller pairs 250 (the left side) pulls the leading edge of the sheet Sh1 inserted into the sheet feed port 24 into the manual feed conveying path 25 and guides the sheet Sh1 to the other manual sheet feeding roller pair 250 (the right side). The other manual sheet feeding roller pair 250 conveys the sheet Sh1 conveyed from the one manual sheet feeding roller pair 250 to the pickup roller 29.

As shown in FIG. 1, each of the image forming units 4 is provided below the intermediate transfer unit 5. Each image forming unit 4 performs an image forming process to form a toner image on a surface of a transfer belt 5A based on image data input from the outside. The image forming units 4 are arranged side by side along the running direction D10 of the transfer belt 5A. From left to right on the transfer belt 5A, a yellow image forming unit 4Y, a cyan image forming unit 4C, a magenta image forming unit 4M, and a black image forming unit 4K are arranged in a line in that order.

Each image forming unit 4 includes a photoconductor drum 41, a charging device 42, a developing device 43, a primary transfer roller 44, and the like. The image forming unit 4Y forms a toner image on a surface of the photoconductor drum 41 using yellow toner. The image forming unit 4C forms a toner image on a surface of the photoconductor drum 41 using cyan toner. The image forming unit 4M forms a toner image on a surface of the photoconductor drum 41 using magenta toner. The image forming unit 4K forms a toner image on a surface of the photoconductor drum 41 using black toner. The toner image is developed on the photoconductor drum 41 by the developing device 43.

The intermediate transfer unit 5 includes a transfer belt 5A, a third drive roller 5B, and a third driven roller 5C. The transfer belt 5A is a circular belt member onto which the toner images of each color formed on the photoconductor drums 41 of the image forming units 4 are transferred. The transfer belt 5A is provided above the photoconductor drums 41. The transfer belt 5A is rotatably supported by the third drive roller 5B and the third driven roller 5C that are spaced apart in the left-right direction D3. The transfer belt 5A is supported so as to be stretched over the third drive roller 5B and the third driven roller 5C. When the surface of the transfer belt 5A passes between the photoconductor drums 41 and the primary transfer rollers 44, the toner images are transferred from the photoconductor drums 41 in order, superimposed on top of each other.

As shown in FIG. 2, the third drive roller 5B is fixed to a rotating shaft 51 extending in the front-rear direction D2, and the rotating shaft 51 is rotatably supported by the internal frame of the housing 11. The driving force from the motor 9 is transmitted to the rotating shaft 51. The driving force of the motor 9 is transmitted to the rotating shaft 51 via a transmission mechanism (not shown) such as a gear or a belt.

The optical scanning device 13 irradiates the photoconductor drum 41 of each image forming unit 4 with laser light based on input image data for each color. Thus, an electrostatic latent image is formed on each of the photoconductor drums 41.

As shown in FIG. 2, the secondary transfer roller 20 is arranged opposite the third drive roller 5B across a conveying path 26 extending in the up-down direction D1. The secondary transfer roller 20 performs a transfer process in which the toner image on the transfer belt 5A is transferred onto a surface (transfer surface) of the sheet Sh1 by a transfer potential applied to the secondary transfer roller 20. The third drive roller 5B and the secondary transfer roller 20 correspond to an image transfer device that transfers an image (toner image) onto the sheet Sh1. The sheet Sh1 onto which the toner image has been transferred is conveyed to the fixing device 16.

As shown in FIG. 2, the fixing device 16 is a part that heats the toner image transferred onto the sheet Sh1 to fix the toner image onto the sheet Sh1, and includes a heating roller 16A and a pressure roller 16B. The sheet Sh1 conveyed to the fixing device 16 is conveyed while being sandwiched between the heating roller 16A and the pressure roller 16B. During conveying, heat is transmitted from the heating roller 16A to the toner image transferred onto the sheet Sh1, and the toner image is heated. Thus, the toner image is fixed on the surface of the sheet Sh1. After that, the sheet Sh1 is discharged onto the sheet tray 18 by the sheet discharge portion 15.

In the present embodiment, the heating roller 16A functions as a drive roller, and the pressure roller 16B functions as a driven roller. More specifically, the heating roller 16A is fixed to a rotating shaft 161 extending in the front-rear direction D2, and the rotating shaft 161 is rotatably supported by the internal frame of the housing 11. The driving force from the motor 9 is transmitted to the rotating shaft 161. The driving force of the motor 9 is transmitted to the rotating shaft 161 via a transmission mechanism (not shown) such as a gear or a belt.

The pressure roller 16B is biased toward the heating roller 16A side by a spring (not shown) with a predetermined elastic force. More specifically, a bearing portion (not shown) that supports a rotating shaft (not shown) of the pressure roller 16B is biased by a spring. Thus, the pressure roller 16B comes into contact with the heating roller 16A while applying a predetermined pressure. In this state, when the heating roller 16A is rotationally driven, the pressure roller 16B is driven.

As shown in FIG. 2, the sheet correction unit 23 is provided on the conveying path 26 on a downstream side of the sheet feeding roller pair 22 in the conveying direction D11. More specifically, the sheet correction unit 23 is provided on the conveying path 26 between a junction of the conveying path 26 and the double-sided printing conveying path 83 and a sensor 72 (described later).

When the conveyed sheet Sh1 is misaligned in the front-rear direction D2 (that is, a width direction of the sheet Sh1), the sheet correction unit 23 returns the sheet Sh1 to a predetermined center position and corrects the misalignment (lateral deviation). In addition, the sheet correction unit 23 conveys the corrected sheet Sh1 to an image transfer device (third drive roller 5B and secondary transfer roller 20) located on the downstream side in the conveying direction D11.

More specifically, the sheet correction unit 23 corrects lateral deviation of the sheet Sh1 in the width direction while the sheet Sh1 that has entered the sheet correction unit 23 is being sandwiched and conveyed between the registration roller 23A and the driven roller 23B. The correction is performed by moving the sheet Sh1 in the width direction in a direction that corrects the lateral deviation (a direction opposite to the deviation direction) by the amount of deviation in the width direction of the sheet Sh1. Note that a mechanism for moving the sheet Sh1 in the width direction is well known, and therefore, a description thereof will be omitted here.

The registration roller 23A is a roller member that is long in the front-rear direction D2. The registration roller 23A is fixed to a rotating shaft 231 extending in the front-rear direction D2, and this rotating shaft 231 is rotatably supported by the internal frame of the housing 11. The driving force from the motor 9 is transmitted to the rotating shaft 231. The driving force of the motor 9 is transmitted to the rotating shaft 231 via a transmission mechanism (not shown) such as a gear or a belt.

The driven roller 23B is biased by a spring (not shown) with a predetermined elastic force toward the registration roller 23A. More specifically, a bearing portion (not shown) that supports a rotating shaft (not shown) of the driven roller 23B is biased by a spring. Thus, the driven roller 23B comes into contact with the registration roller 23A while applying a predetermined pressure. In this state, when the registration roller 23A is rotationally driven, the driven roller 23B is driven.

As shown in FIG. 2, a sensor 72 is provided on the conveying path 26. The sensor 72 detects the leading edge of the sheet Sh1 that has entered the sheet correction unit 23. In the conveying path 26, the sensor 72 is provided on the downstream side of the sheet correction unit 23 in the conveying direction D11 and farther on the upstream side in the conveying direction D11 than the image transfer device (third drive roller 5B and secondary transfer roller 20).

The sensor 72 is, for example, a line sensor extending in the front-rear direction D2. The line sensor is configured by a plurality of image sensors arranged in a row along the front-rear direction D2. The sensor 72 is connected to the control portion 30. The sensor 72 outputs a detection signal to the control portion 30. After acquiring the detection signal from the sensor 72, the control portion 30 determines whether or not the sheet Sh1 has reached the detection position of the sensor 72 based on the detection signal.

Note that the sensor 72 may be an optical sensor. The optical sensor has a light emitting element and a light receiving element, receives reflected light emitted from the light emitting element, and outputs a detection signal according to the amount of light received. The control portion 30 may determine whether or not the conveyed sheet Sh1 has reached the detection position of the sensor 72 based on a change point of the detection signal sent from the optical sensor.

The discharge roller pair 81 is provided on a left side of the sheet discharge port 15A in the sheet discharge portion 15. As shown in FIG. 2, the discharge roller pair 81 receives a driving force from the motor 9 to convey the sheet Sh1 to the sheet discharge port 15A. Thus, the sheet Sh1 is discharged from the sheet discharge port 15A.

In addition, when performing double-sided printing to form images on both sides of the sheet Sh1, the discharge roller pair 81 receives a driving force from the motor 9 and pulls in the sheet Sh1 discharged from the sheet discharge port 15A. Thus, the sheet Sh1 is conveyed to the double-sided printing conveying path 83.

The double-sided printing conveying path 83 is a guide path that guides the sheet Sh1, which has been conveyed again into the housing 11 by the discharge roller pair 81, to the sheet correction unit 23 again. The double-sided printing conveying path 83 curves downward from the discharge roller pair 81 and then extends downward, passing through two double-sided printing feed roller pairs 82 and reaching the sheet correction unit 23. The sheet Sh1 that has passed through the double-sided printing conveying path 83 enters the sheet correction unit 23 with the back surface, which is opposite to the front surface on which an image has already been formed, facing the registration roller 23A. Thus, an image is allowed to be formed on the back side of the sheet Sh1 as well, making double-sided printing possible on the sheet Sh1.

The discharge roller pair 81 includes a fourth drive roller 81A that rotates when a driving force is transmitted from the motor 9, and a fourth driven roller 81B that comes in contact the fourth drive roller 81A and is driven to rotate.

The fourth drive roller 81A is fixed to a rotating shaft 811 extending in the front-rear direction D2, and the rotating shaft 811 is rotatably supported by the internal frame of the housing 11. The driving force from the motor 9 is transmitted to the rotating shaft 811. The driving force of the motor 9 is transmitted to the rotating shaft 811 via a transmission mechanism (not shown) such as a gear or a belt.

The fourth driven roller 81B is biased by a spring (not shown) with a predetermined elastic force toward the fourth drive roller 81A side. More specifically, a bearing portion (not shown) that supports a rotating shaft (not shown) of the fourth driven roller 81B is biased by a spring. Thus, the fourth driven roller 81B comes into contact with the fourth drive roller 81A while applying a predetermined pressure thereto. In this state, when the fourth drive roller 81A is rotationally driven, the fourth driven roller 81B is driven.

As shown in FIG. 2, each of the two double-sided printing feed roller pairs 82 receives a driving force from the motor 9 and conveys the sheet Sh1, which has been conveyed back into the housing 11, toward the downstream side in the conveying direction D13. Each of the double-sided printing feed roller pairs 82 has a fifth drive roller 82A that rotates when a driving force is transmitted from the motor 9, and a fifth driven roller 82B that comes in contact with a fifth drive roller 82A and is rotationally driven.

The fifth drive roller 82A is fixed to a rotating shaft 821 extending in the front-rear direction D2, and the rotating shaft 821 is rotatably supported by the internal frame of the housing 11. The driving force from the motor 9 is transmitted to the rotating shaft 821. The driving force of the motor 9 is transmitted to the rotating shaft 821 via a transmission mechanism (not shown) such as a gear or a belt.

The fifth driven roller 82B is biased by a spring (not shown) with a predetermined elastic force toward the fifth drive roller 82A side. More specifically, a bearing portion (not shown) that supports a rotating shaft (not shown) of the fifth driven roller 82B is biased by a spring. Thus, the fifth driven roller 82B comes into contact with the fifth drive roller 82A while applying a predetermined pressure thereto. In this state, when the fifth drive roller 82A is rotationally driven, the fifth driven roller 82B is driven.

The operation display portion 17 is a user interface of the image forming apparatus 10. The operation display portion 17 has a display portion such as an LCD display that displays various types of information in response to control instructions from the control portion 30, and an operation portion such as operation keys or a touch panel that inputs various types of information to the control portion 30 in response to user operations.

The control portion 30 performs overall control of the image forming apparatus 10. The control portion 30 includes a CPU, a read only memory (ROM), and a random access memory (RAM). The CPU is a processor that executes various types of arithmetic processing. The ROM is a non-volatile storage device that stores in advance information such as control programs for causing the CPU to execute various types of processes. The RAM is a volatile or non-volatile storage device used as a temporary storage memory (work area) for various types of processes executed by the CPU. The CPU performs overall control of the image forming apparatus 10 by executing various types of control programs stored in advance in the ROM.

Note that the control portion 30 may be a control portion provided separately from a main control portion that controls the image forming apparatus 10 in an integrated manner. In addition, the control portion 30 may also be configured by an electronic circuit such as an integrated circuit (application specific integrated circuit (ASIC)).

As shown in FIG. 3, the control portion 30 is electrically connected to the motor 9, the sheet feeding solenoid 71, and the sensor 72 by signal lines or the like. The motor 9 is connected to a conveying control portion 32 included in the control portion 30, and is driven and controlled by receiving a control signal from the conveying control portion 32.

There may be one motor 9, or there may be more than one. In a case in which there is only one motor 9, it is possible to drive the plurality of rollers individually by providing, for example, an electromagnetic clutch or a solenoid so that the motor 9 applies a driving force to the plurality of rollers individually. In addition, in a case in which there is a plurality of motors 9, the plurality of motors 9 can be connected to a plurality of rollers via transmission mechanisms (not shown), respectively, to drive the plurality of rollers individually.

As a related technology, an image forming apparatus is known that synchronizes timing at which a transferred image formed on an intermediate transfer member reaches a transfer position (forming position) with timing at which a sheet reaches the transfer position without stopping conveying of the sheet. In this image forming apparatus, a sheet conveying speed is accelerated or decelerated depending on the timing at which a leading edge of the sheet reaches a detection position so that the leading edge of the sheet reaches at a reference time.

In the image forming apparatus as shown in the related art, the sheet conveying speed is controlled so that the sheet reaches the forming position at the timing when the sheet acceleration or deceleration is completed. Therefore, in a case in which there is variation in the control of the sheet conveying speed, the sheet will reach the forming position in an accelerated or decelerated state, which will result in a problem of reduced accuracy in image formation on the sheet.

In contrast to this, in the present embodiment, the configuration described below makes it possible to implement an image forming apparatus 10 and an operation control method that are less likely to reduce the accuracy of image formation on sheets.

More specifically, as shown in FIG. 3, the image forming apparatus 10 according to the present embodiment includes a conveying roller 230, a motor 9, and a conveying control portion 32. In addition, in the present embodiment, the image forming apparatus 10 further includes a sheet feeding solenoid 71, a sensor 72, and an acquisition processing portion 31. Note that in the present embodiment, the acquisition processing portion 31 and the conveying control portion 32 are both implemented as functions of the control portion 30, but they may be provided separately from the control portion 30.

The conveying roller 230 is a roller that is arranged between the sheet feeding position P1 (see FIG. 2) and the transfer position P2 (see FIG. 2) and conveys the sheet Sh1 along the conveying path 26. Here, the sheet feeding position P1 is a position where the sheet Sh1 is fed to the conveying path 26 by a sheet feeding device (in the present embodiment, the pickup roller 29 and the sheet feeding roller pair 22). More specifically, as shown in FIG. 2, the sheet feeding position P1 is a position (nip position) where two rollers of the sheet feeding roller pair 22 come into contact with each other. The sheet feeding position P1 corresponds to a reference position in the conveying path 26 to which the sheet Sh1 is conveyed. Note that the reference position is not limited to the sheet feeding position P1, but may be any position on the conveying path 26.

The transfer position P2 is a position where an image (toner image) is transferred onto the sheet Sh1 by an image transfer device (third drive roller 5B and secondary transfer roller 20). More specifically, the transfer position P2 is a position (nip position) where the secondary transfer roller 20 and the third drive roller 5B come into contact with each other. The transfer position P2 corresponds to a formation position where forming an image on the sheet Sh1 begins. In the present embodiment, the registration roller 23A corresponds to the conveying roller 230.

The motor 9 is, for example, a stepping motor, and drives each roller including the conveying roller 230 (registration roller 23A). The motor 9 can change the rotational speed of the drive shaft by changing a drive frequency. The motor 9 can change the rotational speed of each roller connected to the motor 9 via a transmission mechanism (not shown) by changing the rotational speed of the drive shaft.

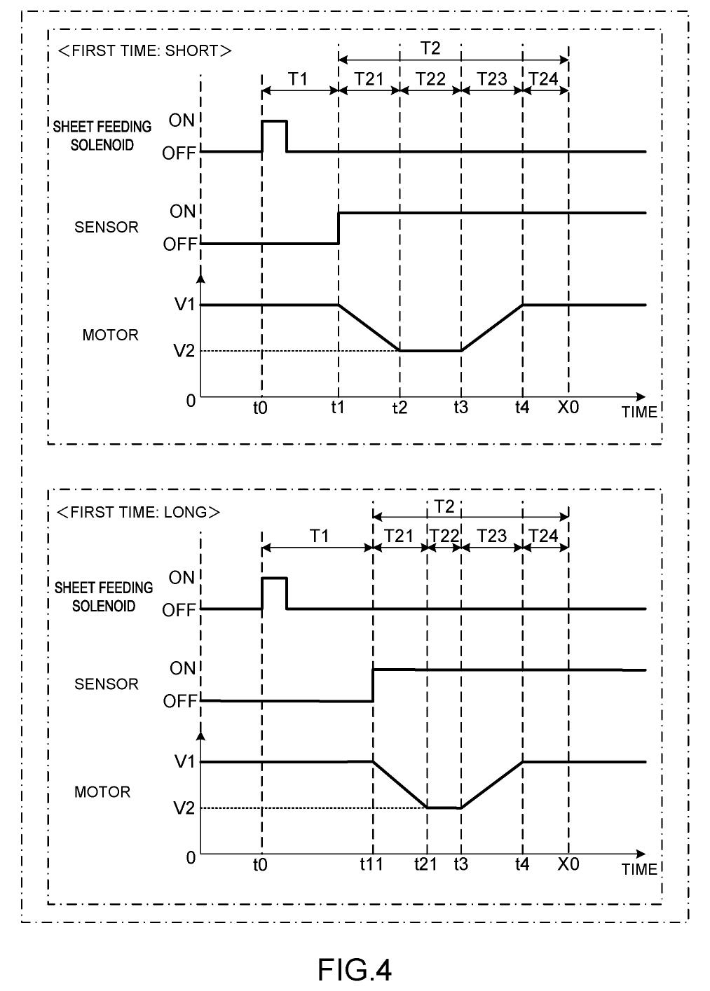

The acquisition processing portion 31 acquires a first time T1 (see FIG. 4) that is the time it takes for the sheet Sh1 to travel from the sheet feeding position P1 to reach the conveying roller 230. In other words, the acquisition processing portion 31 acquires the first time T1 (sheet feeding time) from the sheet feeding position P1 (reference position) until the sheet Sh1 reaches a specific position (position of the conveying roller 230) between the reference position and the transfer position P2 (forming position). More specifically, the acquisition processing portion 31 starts timing when the sheet feeding solenoid 71 is driven (in other words, turned ON), and ends timing when the sensor 72 detects the sheet Sh1. Thus, the acquisition processing portion 31 acquires a time measured from when the sheet feeding solenoid 71 is driven to when the sensor 72 detects the sheet Sh1 as the first time T1.

The conveying control portion 32 controls the motor 9 in accordance with a control instruction from the control portion 30. The conveying control portion 32 controls the motor 9 to control the conveying roller 230, thereby conveying the sheet Sh1 so that the sheet Sh1 reaches the transfer position P2 (forming position) at a transfer timing X0 (see FIG. 4) when the transfer (forming) of the image (toner image) begins. Here, the transfer timing X0 is timing when one end of the image (toner image) on the transfer belt 5A in the running direction D10 reaches the transfer position P2. The transfer timing X0 corresponds to timing at which image formation begins. In addition, the sheet Sh1 arriving at the transfer position P2 means that the leading edge of the sheet Sh1 in the conveying direction D11 reaches the transfer position P2.

The conveying control portion 32 controls the motor 9 and the conveying roller 230 during a specific period, thereby changing the conveying speed of the sheet Sh1 without stopping the sheet Sh1 midway. In addition, the conveying control portion 32 controls the motor 9 to control the conveying roller 230, thereby restoring the conveying speed of the sheet Sh1 to the conveying speed before the speed change before the sheet Sh1 reaches the transfer position P2 (forming position). Here, the specific period is a period from the sheet feeding position P1 (reference position) on the conveying path 26 along which the sheet Sh1 is conveyed until the sheet Sh1 reaches the transfer position P2 (forming position). The specific period corresponds to a period that is a combination of the first time T1 and a second time T2, which will be described later.

### 2 Example of Operation of Image Forming Apparatus

Hereinafter, an example of control of the conveying roller 230 in the image forming apparatus 10 will be described with reference to FIG. 4. In the example shown in FIG. 4, the conveying control portion 32 controls the motor 9 to change the rotational speed of the motor 9, and therefore the rotational speed of the conveying roller 230, during the second time T2 in accordance with the first time T1. The second time T2 is a time from when the sheet Sh1 reaches the conveying roller 230 until when the sheet Sh1 reaches the transfer position P2. In other words, the second time T2 is the time it takes for the sheet Sh1 to travel from a specific position (the position of the conveying roller 230) to the formation position (transfer position P2). More specifically, the second time T2 is the time from timing when the sensor 72 detects the sheet Sh1 to transfer timing X0 when transfer of the image (toner image) begins.

The transfer timing X0 is determined by the control portion 30 based on time required to process formation of an image (toner image) on the transfer belt 5A and time required for one end of the image (toner image) on the transfer belt 5A in the running direction D10 to reach the transfer position P2. Therefore, the second time T2 can be calculated by finding a difference between the transfer timing X0 determined by the control portion 30 and the timing at which the sensor 72 detects the sheet Sh1.

More specifically, at the second time T2, the conveying control portion 32 controls the motor 9 to change the rotational speed of the motor 9 from a first rotational speed V1 to a second rotational speed V2. That is, the conveying control portion 32 changes the conveying speed of the sheet Sh1 during the second time T2 without stopping the sheet Sh1 midway. The first rotational speed V1 is a rotational speed of the motor 9 at the first time T1, and is the rotational speed of the motor 9 during normal operation. That is, the motor 9 rotates at the first rotational speed V1, which is the normal rotational speed, until the sheet Sh1 reaches the conveying roller 230 from the sheet feeding position P1. The second rotational speed V2 is a rotational speed lower than the first rotational speed V1. In the present embodiment, the second rotational speed V2 is, for example, half the first rotational speed V1, which is the normal rotational speed. Note that the second rotational speed V2 does not have to be half the first rotational speed V1, but may be any speed lower than the first rotational speed V1.

For example, in a case in which the motor 9 continues to rotate at the first rotational speed V1, the sheet Sh1 may reach the transfer position P2 before the transfer timing X0. In this case, the leading edge of the sheet Sh1 in the conveying direction D11 and one end of the image (toner image) on the transfer belt 5A in the running direction D10 do not coincide at the transfer position P2, and the image is not transferred onto the sheet Sh1 with high accuracy. Therefore, as described above, the conveying control portion 32 reduces the rotational speed of the motor 9 from the first rotational speed V1 to the second rotational speed V2 during the second time T2. Thus, the sheet Sh1 is allowed to reach the transfer position P2 at the transfer timing X0, making it easier to transfer an image onto the sheet Sh1 with high accuracy.

In addition, the conveying control portion 32 changes the rotational speed of the motor 9 in accordance with the first time T1 acquired by the acquisition processing portion 31, as described above. Here, the first time T1 may vary due to slippage of the sheet Sh1, for example, due to the load of conveying the sheet Sh1 when the pickup roller 29 or the sheet feeding roller pair 22 begin to rotate, or the condition of the surface of the sheet Sh1 (such as variations in the coefficient of friction). Therefore, the conveying control portion 32 changes the rotational speed of the motor 9 according to the first time T1, thereby making it possible for the sheet Sh1 to reach the transfer position P2 at the transfer timing X0, regardless of variations in the first time T1.

More specifically, the conveying control portion 32 changes the rotational speed of the motor 9 so that a sum of the first time T1 and the second time T2 becomes a predetermined constant value. For example, in a case in which the first time T1 is shorter than a reference time, the conveying control portion 32 changes the rotational speed of the motor 9 so that the second time T2 is longer by a difference between the first time T1 and the reference time. In addition, for example, in a case in which the first time T1 is longer than a reference time, the conveying control portion 32 changes the rotational speed of the motor 9 so that the second time T2 is shorter by the difference between the first time T1 and the reference time.

In the present embodiment, the second time T2 includes a deceleration time T21, a first maintenance time T22, an acceleration time T23, and a second maintenance time T24. The deceleration time T21 is a time required for the rotational speed of the motor 9 to be decelerated from the first rotational speed V1 to the second rotational speed V2. The conveying control portion 32 changes the drive frequency of the motor 9 to reduce the rotational speed of the motor 9 at a predetermined deceleration. The deceleration time T21 corresponds to a speed change period during which the conveying speed of the sheet Sh1 is changed.

The first maintenance time T22 is a time period after the deceleration time T21 during which the rotational speed of the motor 9 is maintained at the second rotational speed V2. The conveying control portion 32 controls the drive frequency of the motor 9 so as to be constant, thereby maintaining the rotational speed of the motor 9. The first maintenance time T22 corresponds to a second maintenance period during which the conveying speed of the sheet Sh1 is maintained at the speed after the speed change from when the conveying speed of the sheet Sh1 is changed until when the conveying speed is returned to normal. That is, the conveying control portion 32 controls the conveying speed of the sheet Sh1 so that the first maintenance time T22 (second maintenance period) is included between when the conveying speed of the sheet Sh1 is changed and when the conveying speed is returned to normal.

The acceleration time T23 comes after the first maintenance time T22 and is a time during which the rotational speed of the motor 9 is accelerated from the second rotational speed V2 to the first rotational speed V1. The conveying control portion 32 changes the drive frequency of the motor 9 to accelerate the rotational speed of the motor 9 at a predetermined acceleration. Here, absolute values of the deceleration and acceleration are the same. The acceleration time T23 corresponds to a recovery period during which the conveying speed of the sheet Sh1 is restored to the conveying speed before the change.

In addition, in the present embodiment, the second time T2 further includes a second maintenance time T24. The second maintenance time T24 is a time period after the acceleration time T23 during which the rotational speed of the motor 9 is maintained at the first rotational speed V1. The conveying control portion 32 controls the drive frequency of the motor 9 so as to be constant, thereby maintaining the rotational speed of the motor 9. The second maintenance time T24 is determined so that a distance between the leading edge of the sheet Sh1 in the conveying direction D11 and the transfer position P2 at the start of the second maintenance time T24 is approximately several mm, for example. The second maintenance time T24 corresponds to a first maintenance period in which the conveying speed of the sheet Sh1 is maintained at the speed before the speed change. In other words, the conveying control portion 32 controls the conveying speed of the sheet Sh1 so that the second maintenance time T24 (first maintenance period) is included between a time when the conveying speed of the sheet Sh1 is restored to the conveying speed before the speed change and a time when the sheet Sh1 reaches the transfer position P2 (forming position).

This makes it possible to stabilize the speed at which the sheet Sh1 is conveyed before the sheet Sh1 reaches the transfer position P2 (forming position). Therefore, there is an advantage in that accuracy of image formation on the sheet Sh1 is less likely to decrease compared to when the sheet Sh1 reaches the transfer position P2 in an accelerated or decelerated state.

Furthermore, in the present embodiment, length of the second maintenance time T24 (first maintenance period) is constant regardless of the first time T1 (sheet feeding time). Thus, it is possible to prevent the second maintenance time T24 from becoming too short depending on the length of the first time T1, and makes it possible to prevent the sheet Sh1 from arriving at the transfer position P2 (forming position) in a decelerated or accelerated state. Therefore, compared to a case in which the second maintenance time T24 is changed depending on the first time T1, there is an advantage in that it is easier to prevent accuracy of image formation on the sheet Sh1 from decreasing.

More specifically, as shown in FIG. 4, the conveying control portion 32 first decelerates the rotational speed of the motor 9 from the first rotational speed V1 to the second rotational speed V2 at a predetermined deceleration during the deceleration time T21. Next, the conveying control portion 32 maintains the rotational speed of the motor 9 at the second rotational speed V2 during the first maintenance time T22. Next, during the acceleration time T23, the conveying control portion 32 accelerates the rotational speed of the motor 9 from the second rotational speed V2 to the first rotational speed V1 at a predetermined acceleration rate. After that, the conveying control portion 32 maintains the rotational speed of the motor 9 at the first rotational speed V1 during the second maintenance time T24.

As described above, the conveying control portion 32 controls the motor 9 so that the second time T2 includes the first maintenance time T22, or in other words, so that the second time T2 includes the time during which the rotational speed of the motor 9 is maintained at the second rotational speed V2. Thus, it is possible for the length of the first maintenance time T22 to be changed according to the first time T1, making it possible for the sheet Sh1 to reach the transfer position P2 at the transfer timing X0 regardless of variations in the first time T1. In addition, in this case, the lengths of the deceleration time T21 and the acceleration time T23 do not need to be changed in accordance with the first time T1. Therefore, control for changing the rotational speed of the motor 9 becomes easier compared to a case in which the deceleration time T21 and the acceleration time T23 are changed.

More specifically, in the example shown in <First Time: Short> in FIG. 4, the first time T1 is a time from time t0 when the paper feed solenoid 71 is turned ON to time t1 when the sensor 72 detects the sheet Sh1. The second time T2 is a time from time t1 to the transfer timing X0, the deceleration time T21 is a time from time t1 to time t2, the first maintenance time T22 is a time from time t2 to time t3, and the acceleration time T23 is a time from time t3 to time t4. In addition, the second maintenance time T24 is set to a time from time t4 to the transfer timing X0.

On the other hand, in the example shown in <First time: Long> in FIG. 4, the first time T1 is a time from time t0 when the sheet feeding solenoid 71 turns ON to time t11 (> t1) when the sensor 72 detects the sheet Sh1, and is longer than the example shown in <First time: Short>. The second time T2 is a time from time t11 to the transfer timing X0, the deceleration time T21 is a time from time t11 to time t21 (> t2), and the first maintenance time T22 is a time from time t21 to time t3. In addition, the acceleration time T23 is set to a time from time t3 to time t4, and the second maintenance time T24 is set to a time from time t4 to the transfer timing X0. Note that the length of the deceleration time is the same as the length of the deceleration time in the example of <First time: Long>.

In other words, in the example shown in <First time: Long> in FIG. 4, the conveying control portion 32 controls the motor 9 to change the length of only the first maintenance time T22 as the first time T1 becomes longer. Therefore, in both the examples of <First time: Short> and <First time: Long> in FIG. 4, the lengths of the deceleration time T21, the acceleration time T23, and the second maintenance time T24 are the same.

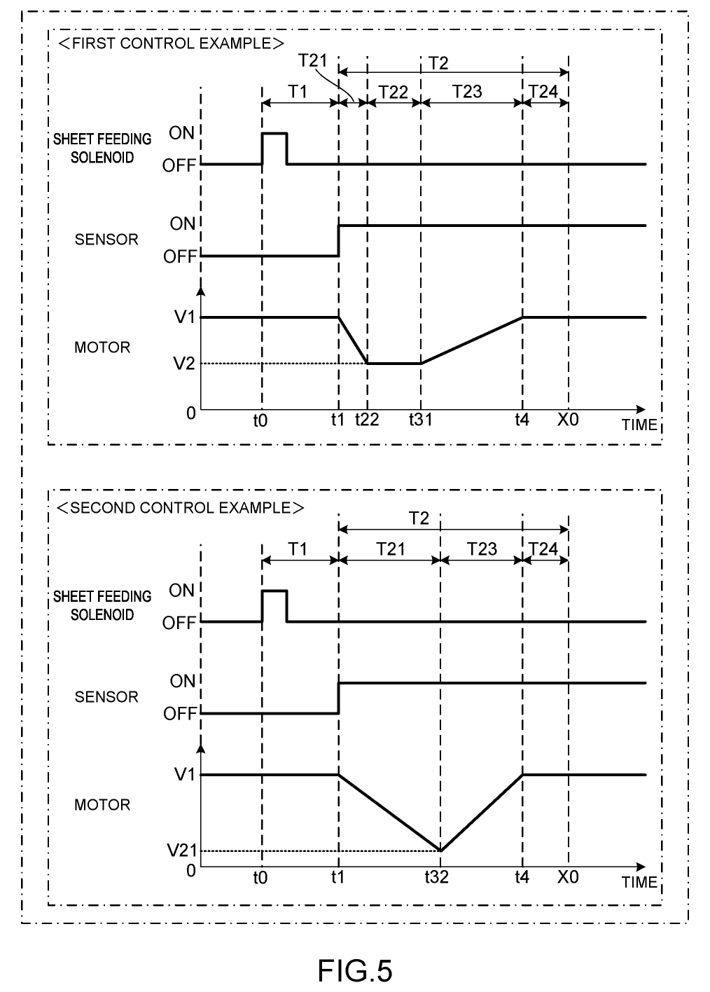

Here, the conveying control portion 32 may adjust the length of the second time T2 by controlling the motor 9 to change other parameters in addition to changing the first maintenance time T22. For example, as shown in the <First Control Example> of FIG. 5, the conveying control portion 32 may adjust the length of the second time T2 by controlling the motor 9 to change each of the deceleration time T21 and the acceleration time T23. More specifically, the conveying control portion 32 adjusts the length of the second time T2 by increasing the deceleration rate during the deceleration time T21 to shorten the length of the deceleration time T21, and by increasing the acceleration rate during the acceleration time T23 to lengthen the length of the acceleration time T23.

Here, the deceleration time T21 is set to a time from time t1 to time t22 (< t2), and the first maintenance time T22 is set to a time from time t22 to time t31 (< t3). In addition, the acceleration time T23 is set to a time from time t31 to time t4, and the second maintenance time T24 is set to a time from time t4 to the transfer timing X0.

In addition, for example, as shown in the <Second Control Example> of FIG. 5, the conveying control portion 32 may adjust the length of the second time T2 by controlling the motor 9 to reduce the rotational speed of the motor 9 to a rotational speed V21 that is even smaller than the second rotational speed V2. More specifically, the conveying control portion 32 controls the motor 9 so that the rotational speed of the motor 9 is reduced to the rotational speed V21 during the deceleration time T21, and is increased to the first rotational speed V1 during the acceleration time T23. Thus, the length of the second time T2 is adjusted.

Here, the deceleration time T21 is set to a time from time t1 to time t32 (t2 < t32 < t3), the acceleration time T23 is set to a time until time t4, and the second maintenance time T24 is set to a time from time t4 to the transfer timing X0. In this case, the second time T2 does not include the first maintenance time T22, or may include the first maintenance time T22.

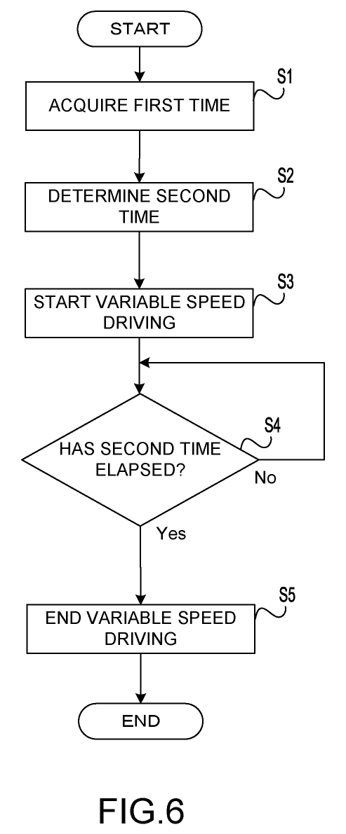

Hereinafter, an example of a procedure of the process executed by the image forming apparatus 10 and an example of the operation control method of the present embodiment will be described with reference to FIG. 6. Here, steps S1, S2, and so on represent numbers of processing procedures (steps) executed by the image forming apparatus 10. The process described below is executed when an image is formed on a sheet Sh1 stored in the sheet storing portion 27 or on a manually fed sheet.

### Step S1

First, the acquisition processing portion 31 of the image forming apparatus 10 acquires the first time T1. More specifically, the acquisition processing portion 31 acquires a time measured from when the sheet feeding solenoid 71 is driven to when the sensor 72 detects the sheet Sh1 as the first time T1 (sheet feeding time).

### Step S2

Next, the conveying control portion 32 determines the second time T2 based on the first time T1 (sheet feeding time) acquired by the acquisition processing portion 31. More specifically, the conveying control portion 32 changes the rotational speed of the motor 9 so that a sum of the first time T1 and the second time T2 becomes a predetermined constant value.

### Step S3

Next, the conveying control portion 32 starts variable speed driving to change the rotational speed of the motor 9. More specifically, at the second time T2, the conveying control portion 32 controls the motor 9 to change the rotational speed of the motor 9 from a first rotational speed V1 to a second rotational speed V2.

### Step S4

The conveying control portion 32 executes variable speed driving until the second time T2 has elapsed (step S3: NO). When the second time T2 has elapsed (step S3: YES), the conveying control portion 32 executes step S5.

### Step S5

The conveying control portion 32 ends the variable speed driving. Thus, the rotational speed of the motor 9 returns to the first rotational speed V1. Then, at the transfer timing X0, the leading edge of the sheet Sh1 in the conveying direction D11 reaches the transfer position P2, and transfer of the image (toner image) onto the sheet Sh1 begins.

As described above, the image forming apparatus 10 according to the present embodiment changes the rotational speed of the conveying roller 230 (registration roller 23A) without stopping so that the sheet Sh1 reaches the transfer position P2 at the transfer timing X0 when the transfer of the image (toner image) begins. Therefore, in the present embodiment, there is no need to wait for the sheet Sh1 at the conveying roller 230, and thus the time required to convey the sheet Sh1 to the transfer position P2 is shorter than when the sheet Sh1 is made to wait at the conveying roller 230. Therefore, in the present embodiment, the time required to form an image on one sheet Sh1 and output the sheet Sh1 is shorter than when the sheet Sh1 is left waiting at the conveying roller 230, and thus it is possible to increase the number of sheets Sh1 output per unit time. Note that the number of sheets Sh1 output per unit time is, for example, paper per minute (PPM), which is the number of prints (outputs) of sheets Sh1 per minute.

In addition, in the present embodiment, the number of sheets Sh1 output per unit time can be increased without increasing the rotational speed of the motor 9, so driving noise of the motor 9 can be prevented from increasing, and quietness is less likely to decrease.

Moreover, in the present embodiment, the conveying speed of the sheet Sh1 is returned to the conveying speed before the speed change (first rotational speed V1) before the sheet Sh1 reaches the transfer position P2 (forming position). Thus, it is possible to stabilize the conveying speed of the sheet Sh1 before the sheet Sh1 reaches the transfer position P2. Therefore, there is an advantage in that accuracy of image formation on the sheet Sh1 is less likely to decrease compared to when the sheet Sh1 reaches the transfer position P2 in an accelerated or decelerated state.

That is, during image formation, the image is formed on the sheet Sh1 on the assumption that the conveying speed of the sheet Sh1 is the normal speed (first rotational speed V1). As a result, variations occur in the control of the conveying speed of the sheet Sh1, and when sheet Sh1 reaches the transfer position P2 (forming position) at a speed faster or slower than normal, the position of image formation on sheet Sh1 may be shifted. In contrast to this, in the present embodiment, the conveying speed of the sheet Sh1 is returned to the normal speed before the sheet Sh1 reaches the transfer position P2. Therefore, even when there is variation in the control of the conveying speed of the sheet Sh1, it is easy to stabilize the conveying speed of the sheet Sh1 at a normal speed when the sheet Sh1 reaches the transfer position P2, and misalignment of the image formed on sheet Sh1 is unlikely to occur.

### Modification

In the above embodiment, in a case in which the first time T1 is longer than a threshold time, the conveying control portion 32 may change the rotational speed of the motor 9 to a rotational speed higher than the first rotational speed V1 at the second time T2. In other words, when the first time T1 is relatively long and the rotational speed of the motor 9 is equal to or lower than the first rotational speed V1, the conveying control portion 32 may accelerate the motor 9 in a case in which the sheet Sh1 does not reach the transfer position P2 by the transfer timing X0. In the present embodiment, the driving noise of the motor 9 increases due to the acceleration of the motor 9; however, this only occurs during part of the second time T2, and thus the effect on quietness is small. In addition, in a case in which the sheet Sh1 does not reach the transfer position P2 at the transfer timing X0, the image (toner image) transferred onto the transfer belt 5A must be discarded once; however, in the present embodiment, the image transferred onto the transfer belt 5A does not need to be discarded.

In the above embodiment, the conveying control portion 32 may control the motor 9 so as to change the rotational speed of the motor 9 without taking the first time T1 into consideration. In this case, the image forming apparatus 10 does not need to include the acquisition processing portion 31. In addition, in this case, the conveying control portion 32 may change the rotational speed of the motor 9 so that the sheet Sh1 reaches the transfer position P2 at the transfer timing X0 without waiting for the sheet Sh1 to reach the conveying roller 230.

In the above embodiment, the registration roller 23A is the conveying roller 230, but is not limited to this. For example, the conveying roller 230 does not need to have a function of correcting lateral deviation of the sheet Sh1 as the registration roller 23A does. In other words, the conveying roller 230 only needs to have the function of conveying the sheet Sh1 along the conveying path 26 to the transfer position P2.

In the above embodiment, the sensor 72 is located on the downstream side of the conveying roller 230 (registration roller 23A) in the conveying direction D11, but is not limited to this. For example, the sensor 72 may be located on the upstream side of the conveying roller 230 in the conveying direction D11.

In the above embodiment, a relationship between the drive roller and the driven roller in each roller pair may be reversed. For example, in the sheet feeding roller pair 22, the first drive roller 22A may be a driven roller, and the first driven roller 22B may be a drive roller. In addition, in the above embodiment, both of the two rollers in each roller pair may be drive rollers.

In the above embodiment, the image forming apparatus 10 does not necessarily have to have a double-sided printing function. In a case in which the image forming apparatus 10 does not have a double-sided printing function, a configuration related to a double-sided printing function is not necessary. More specifically, in this case, the image forming apparatus 10 does not need to include two double-sided sheet feeding roller pairs 82 and the double-sided printing conveying path 83.

In the above embodiment, the image forming apparatus 10 has a printing function of forming a monochrome image or a color image on a sheet Sh1; however, is not limited to this. For example, the image forming apparatus 10 may have a printing function of forming only a monochrome image on a sheet Sh1.

In the above embodiment, the image forming apparatus 10 has a function of executing a process of forming a monochrome image or a color image on a sheet Sh1 based on an electrophotographic method; however, is not limited to this. For example, the image forming apparatus 10 may have a function of executing a process of forming a monochrome image or a color image on a sheet Sh1 based on an inkjet method.

### Supplementary Notes

An outline of the technique according to the disclosure extracted from the above-described embodiments will be added below. Note that the configurations and processing functions described in the following supplementary notes can be selected and combined as desired.

### Supplementary Note 1

An image forming apparatus, including:
a conveying control portion configured to convey a sheet so that the sheet reaches a forming position at a timing when image formation begins; wherein
the conveying control portion,
during a specific period from a reference position on a conveying path along which the sheet is conveyed until the sheet reaches the forming position,
changes a conveying speed of the sheet without stopping the sheet during conveying; and
restores the conveying speed of the sheet to the conveying speed before the speed change before the sheet reaches the forming position.

### Supplementary Note 2

The image forming apparatus according to Supplementary Note 1, wherein the conveying control portion,
during a period from the time the conveying speed of the sheet returns to the conveying speed before the speed change until the sheet reaches the forming position,
controls the conveying speed of the sheet so that a first maintenance period is included in which the conveying speed of the sheet is maintained at the speed before the speed change.

### Supplementary Note 3

The image forming apparatus according to Supplementary Note 1 or 2, wherein
the conveying control portion,
during a period from when the conveying speed of the sheet is changed to when the conveying speed is restored,
controls the conveying speed of the sheet so that a second maintenance period is included in which the conveying speed of the sheet is maintained at the speed after the speed change.

### Supplementary Note 4

The image forming apparatus according to any one of Supplementary Notes 1 to 3, further including
an acquisition processing portion configured to acquire a sheet feeding time from the reference position until the sheet reaches a specific position between the reference position and the forming position; wherein
the conveying control portion,
depending on the sheet feeding time,
changes at least one of a length of a speed change period during which the conveying speed of the sheet is changed and a length of a recovery period during which the conveying speed of the sheet is restored to the conveying speed before the speed change.

### Supplementary Note 5

The image forming apparatus according to Supplementary Note 4, wherein
the conveying control portion,
during a period from when the conveying speed of the sheet is restored to the conveying speed before the speed change until the sheet reaches the forming position,
controls the conveying speed of the sheet so as to include a first maintenance period in which the conveying speed of the sheet is maintained at the speed before the speed change; and
keeps a length of the first maintenance period constant regardless of the sheet feeding time.

### Supplementary Note 6

An image forming apparatus control method including:
conveying a sheet so that the sheet reaches a forming position at a timing when image formation begins; and
during a specific period from a reference position on a conveying path along which the sheet is conveyed until the sheet reaches the forming position,
changing a conveying speed of the sheet without stopping the sheet during conveying; and
restoring the conveying speed of the sheet to the conveying speed before the speed change before the sheet reaches the forming position.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a conveying control portion configured to convey a sheet so that the sheet reaches a forming position at a timing when image formation begins; wherein
the conveying control portion,
during a specific period from a reference position on a conveying path along which the sheet is conveyed until the sheet reaches the forming position,
changes a conveying speed of the sheet without stopping the sheet during conveying; and
restores the conveying speed of the sheet to the conveying speed before the speed change before the sheet reaches the forming position.

2. The image forming apparatus according to claim 1, wherein
the conveying control portion,
during a period from the time the conveying speed of the sheet returns to the conveying speed before the speed change until the sheet reaches the forming position, controls the conveying speed of the sheet so that a first maintenance period is included in which the conveying speed of the sheet is maintained at the speed before the speed change.

3. The image forming apparatus according to claim 1, wherein
the conveying control portion,
during a period from when the conveying speed of the sheet is changed to when the conveying speed is restored,
controls the conveying speed of the sheet so that a second maintenance period is included in which the conveying speed of the sheet is maintained at the speed after the speed change.

4. The image forming apparatus according to claim 1, wherein
an acquisition processing portion configured to acquire a sheet feeding time from the reference position until the sheet reaches a specific position between the reference position and the forming position; wherein
the conveying control portion,
depending on the sheet feeding time,
changes at least one of a length of a speed change period during which the conveying speed of the sheet is changed and a length of a recovery period during which the conveying speed of the sheet is restored to the conveying speed before the speed change.

5. The image forming apparatus according to claim 4, wherein
the conveying control portion,
during a period from when the conveying speed of the sheet is restored to the conveying speed before the speed change until the sheet reaches the forming position, controls the conveying speed of the sheet so as to include a first maintenance period in which the conveying speed of the sheet is maintained at the speed before the speed change; and
keeps a length of the first maintenance period constant regardless of the sheet feeding time.

6. An image forming apparatus control method, comprising:
conveying a sheet so that the sheet reaches a forming position at a timing when image formation begins; and
during a specific period from a reference position on a conveying path along which the sheet is conveyed until the sheet reaches the forming position,
changing a conveying speed of the sheet without stopping the sheet during conveying; and
restoring the conveying speed of the sheet to the conveying speed before the speed change before the sheet reaches the forming position.
